(19) United States
(12) Patent Application Publication
(10) Pub. No.: US 2008/0309547 A1
(43) Pub. Date: Dec. 18, 2008

(54) Method and Apparatus for Optimizing Emission in Pulse Echo Methods

(76) Inventor: Bernhard Michalski, Maulburg (DE)

Correspondence Address: BACON & THOMAS, PLLC, 625 SLATERS LANE, FOURTH FLOOR, ALEXANDRIA, VA, 22314-1176, US

(21) Appl. No.: 10/583,357

(22) PCT Filed: Dec. 14, 2004
(86) PCT No.: PCT/EP2004/053459

§ 371 Date: Aug. 25, 2008

(30) Foreign Application Priority Data
Dec. 17, 2003 (DE) 10359534.1

(51) Int. Cl. G01S 13/08

(52) U.S. Cl. 342/137

(57) ABSTRACT

Emission values of pulse echo methods known to this point in time, especially those, which are used in industrial measurements technology for fill level measurements, frequently reach the allowable limit values. To avoid possible radio permitting of such measuring devices, the invention provides a method and a circuit for optimizing emission of broadband transmission pulses of a pulse echo method, wherein the transmission pulses are transmitted with a pre-selected pulse repetition frequency. The method and circuit of the invention provide that the polarity of a pulse is switched with each cycle of the pulse repetition frequency, depending on a random sequence, or that individual pulses are suppressed with each cycle of the pulse repetition frequency, depending on a random sequence.

The invention relates to a method and apparatus for optimizing emission in pulse echo methods utilizing electromagnetic signals. The invention relates especially to a method and apparatus for optimizing emission in the case of broadband pulse-radar methods, such as are used in industrial measurements technology in the context of process automation for exact distance determination of fixed and moving targets.

A known pulse radar method involves, for example, the continuous determination of a fill level of a medium in a container or tank. In industrial process measurements technology, such measurements are performed with pulse radar signals, which are transmitted toward the medium from a measuring device, also referred to as a transmitter, placed, in most cases, above in the tank or container. The signals are reflected from the medium and are received by the measuring device as so-called echo signals. In principle, in this method, a time-transformed, intermediate frequency signal is produced by means of a transmitted pulse sequence and a scanning pulse sequence having a slightly difference pulse repetition frequency. This intermediate frequency signal is amplified, demodulated and evaluated for the travel time of the measurement signal. From the travel time of a measurement signal, the distance between measuring device and medium is determined, from which, knowing the geometry of the container or tank, the sought fill level is determined.

It is expedient to locate the measuring device above the medium and above the highest expected fill level of the medium in the container or tank. Pulse radar signals are, for such purpose, usually either emitted freely from the measuring device or else guided into the medium on a wave guide extending into the medium. The accuracy of measurement depends on the dielectric constant (also referred to as the DC-value) of the medium.

The pulse radar signals used for the described fill level measurements are very broadbanded and exhibit transmission pulse spectra in the range of a few MHz up into the GHz range. They do, however, exactly because of these frequencies, present ever more problems with their emission values, which often come up against the allowable limit values of radio and other permits, such as e.g. in the case of the so-called CE-sign. Manufacturers of measuring devices for industrial process measurements technology, when such devices work with pulse radar signals, normally, however, have no interest in having a radio permit for these measuring devices.

In order to keep the emission values of the measuring devices using pulse radar signals below those limit values above which a radio permit is required, it has been the practice, to this point in time, to us techniques, which detract from measurement performance, or from the range of use. Some techniques for decreasing emission, and the limitations associated therewith, are mentioned here as follows:
A lessening of the transmission level leads to a correspondingly smaller echo signal. Especially in the case of large measurement distances and low DC-values of the medium, however, the certainty of obtaining an unequivocal echo signal is correspondingly decreased.
A lessening of the pulse repetition rate does decrease emission, but also degrades the measuring speed and/or resolution of the wanted signals.

If, on the other hand, it is not possible to lessen the emission of the pulse radar signals for fill level measurements, then an operation of the relevant measuring device is only possible in closed metal containers or tanks, when the required emission limit for industrial environment is not sufficient. In the case of non-metal containers, there remains then only an operation using pulse radar signals guided on a wave guide, wherein the wave guide should be a coaxial probe.

The described problems are of a fundamental nature, and many manufacturers of measuring devices using radar pulse signals have, to this point, made only insignificant progress. Moreover, notices concerning limitations of use relative to CE-regulations have to be placed in the operating instructions.

For measuring devices with narrow-band radar signals, another possibility was earlier developed for limiting the emission values of the pulse radar signals. German Patent DE-4207626-C2 describes how a single frequency of a narrow band radar pulse signal serving as measuring signal of a measuring device can be shifted in phase by pi rad, or 180°, in the sense of a phase modulation. According to DE-4207626-C2, for this purpose, the phase of the carrier frequency of the radar wave pulse sequence and the phase of the sampling pulse sequence are synchronously modulated by the same, pseudo-statistical, binary sequence. This method leads to a reduction of the high emission values; more exactly, to a reduction of the spectral-line power by conversion into a equally formed, low spectral power density. It concerns, however, only a single frequency of the considered spectrum and is, consequently, not suited for broadband radar pulse signal methods, because it fails in this case. For fill level measurements in industrial measurements technology, broadband radar pulse signals are, however, used, which, in fact, contain very many single-frequency components. If one would apply the method of DE-4207626-C2 to this, each frequency component would have to be shifted its particular pi rad, which would lead to a different time shift for each component. Consequently, the method of DE-4207626-C2 is not suited for industrial fill level measurement technology using broadband pulse radar signals. Additionally, it is known for fill level measurements with broadband radar pulse signals that, in the case of very short, needle pulses, the interference spectrum can extend over a plurality of frequency decades from a few MHz to a few GHz, so that, depending on signal form, amplitude and pulse repetition frequency, the allowable, or desired, emission values can easily be exceeded. In order to minimize the emission level, it has been attempted to modulate the pulse repetition frequency, or to provided it with a phase jitter, as the case may be. However, especially in the case of purely digitally constructed, fill level measuring devices, in which the pulse repetition frequency is controlled by a quartz element, this is associated with increased complexity, because analog components are needed.

An object of the invention, therefore, is to provide a method and an apparatus for optimizing emission in the case of broadband pulse radar methods, which avoid the above-discussed disadvantages and which also enable the use of a quartz-precise pulse repetition frequency usual in industrial measurements technology.

This object is achieved by a method for optimizing emission of broadband transmission pulses of a pulse echo method, in which the transmission pulses are transmitted with a preselected pulse repetition frequency, wherein the polarity of a pulse is randomly switched in each cycle of the pulse repetition frequency.

In a special embodiment of the method of the invention, the pulse repetition frequency is constant.

In another embodiment of the method of the invention, the pulse repetition frequency is also jittered.

Yet another execution of the method of the invention works with transmission pulses of arbitrary pulse shape.

The above-recited object is also achieved by a first variant of a circuit for optimizing emission of broadband transmission pulses of a pulse echo method, wherein the circuit includes two transmission signal generators of different polarity, with switching back and forth between their output signals occurring, depending on a produced random sequence.

The above-recited object is also achieved by a second variant of a circuit for optimizing emission of broadband transmission pulses of a pulse echo method, wherein the circuit includes two transmission signal generators of different polarity, which are switched in, and out, depending on a produced random sequence.

Finally, the above-recited object is achieved by a third variant of a circuit for optimizing emission of broadband transmission pulses of a pulse echo method, wherein the circuit includes a transmission signal generator which can be switched as regards its polarity and which is switched, depending on a produced random sequence.

In a special form of embodiment of the circuit of the invention, the random sequence is a PN-code sequence, which is produced by a PN-code generator circuit.

In another embodiment of the circuit of the invention, the PN-code generator circuit includes a multistage shift register with feedback taps.

A further form of embodiment of the circuit of the invention includes an XOR-gate for the feedback taps.

Basically, the invention rests on the recognition that a shift of a broadband signal by pi is none other than a reversal of the polarity of the broadband signal, or a multiplication of the signal by the factor −1. Such a reversal of polarity of a broadband signal, especially one for industrial measurement methods, is safely implemented according to the invention. Especially the embodiments of the circuit of the invention using shift registers for producing the random sequence, which controls the switching of the polarity and, so-to-say, codes the polarity, enables an exact periodicity of the transmission signals and, therewith, a reproducibly favorable effect on the emission values. The greater the number of shift registers used, the longer the time, until the series of optimized transmission signals repeats.

A further advantage of the invention is to be seen in the fact that it permits the use of any signal form of a pulse radar signal, since the coding of the polarity of the transmission signals according to the invention occurs independently of the signal form.

Altogether, it is to be noted that the emission value of broadband pulse radar signals with the polarity coding of the transmission pulses according to the invention is significantly minimized, although the transmission level and/or the pulse repetition rate can be additionally increased. Thus leads, in the case of measuring methods, especially in the case of fill level measurements using pulse radar methods, to an increase in the measuring performance and offers, additionally, the advantage that a distinguishing of applicability for metal containers or free field becomes easier. Consequently, also fill level measurements using broadband pulse radar signals in glass or plastic containers are possible, which were not performable with previously usual broadband pulse radar transmission signals, due to overly strong emission values. Indirectly, also, the resistance of the signals to disturbances improves, because the levels of the wanted signals, thus the wanted echoes, are greater, compared under equal conditions in previous measuring methods. Additionally, phantom echo signals, which arise due to over-range effects, are suppressed.

The invention will now be explained and described in greater detail on the basis of examples of embodiments, with reference being made to the appended drawing, the figures of which show as follows:

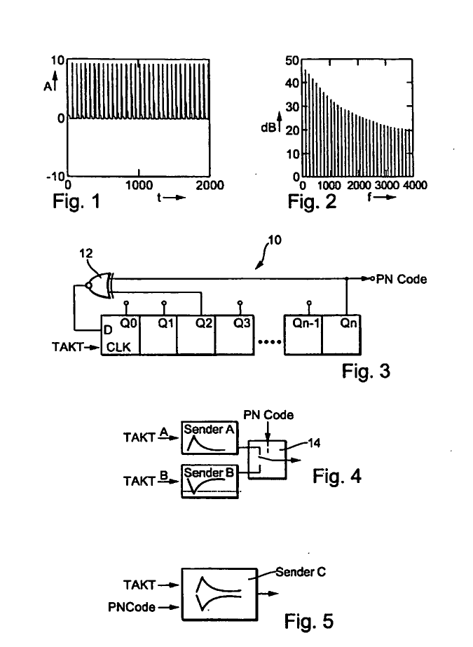

FIG. 1 representation of time behavior of a conventional broadband pulse radar signal;

FIG. 2 representation of the frequency spectrum of the broadband pulse radar signal of FIG. 1;

FIG. 3 an example of an embodiment of a circuit of a PN-code generator of the invention;

FIG. 4 a first example of an embodiment of a circuit of the invention for producing a transmission signal having coded polarity;

FIG. 5 a second example of an embodiment of a circuit of the invention for producing a transmission signal having coded polarity;

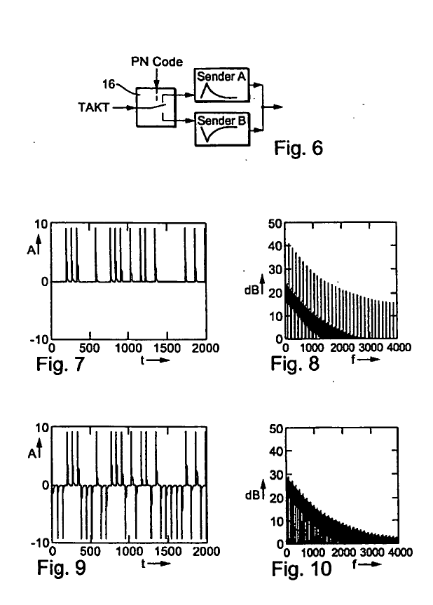

FIG. 6 a third example of an embodiment of a circuit of the invention for producing a transmission signal having coded polarity;

FIG. 7 representation of time behavior of a coded, broadband pulse radar signal;

FIG. 8 representation of the frequency spectrum of the coded, broadband pulse radar signal of FIG. 7;

FIG. 9 representation of time behavior of a broadband pulse radar signal polarity coded according to the invention and having improved coding compared with the signal presented in FIG. 7; and

FIG. 10 representation of the frequency spectrum of the broadband, polarity-coded, pulse radar signal of FIG. 9.

In the drawing, the label TAKT is translatable as CLOCK but, being a label, it has been left as such.

The invention will be described in the following, without limitation of the fundamental concepts of the invention, on the basis of examples of embodiments for a circuit, and a method, for a TDR fill level measurement of industrial measurements technology. Beyond these examples, the invention is suited for optimizing emission in the widest variety of broadband pulse radar methods.

The so-called TDR measurement method is a pulse echo method, in which extremely broadband, transmission pulse signals are transmitted in the microwave region from a fill level measuring device. A wave guide, which is connected with the fill level measuring device in which the transmission signals are produced and processed, usually extends for this purpose into the medium whose fill level in a container or tank is to be measured. The transmission pulse signals are guided on the wave guide to the medium, on whose upper surface they are reflected. They then run back on the wave guide to the measuring device, as the wanted echo signal. Although the greatest part of the signal energy stays on the wave guide as the wanted signal and is recaptured as the wanted echo signal, a certain fraction of the energy is radiated away. Depending on signal form, amplitude and pulse repetition frequency (PRF), the emission values can, in such case, very rapidly exceed prescribed, or permitted, limit values and cause interferences of varied type. Since, in the case of TDR measurement methods, until now, very short, positive needle pulses have been transmitted, such as illustrated, for example, in FIG. 1, the interference spectrum extends over a plurality of frequency decades, from a few MHz up to a few GHz. The usually arising spectrum is composed of spectral lines, whose heights, e.g. in the case of such a needle pulse, decrease in the direction of higher frequencies, as illustrated in FIG. 2. The separation of the individual spectral lines following one after the other is determined by the pulse repetition rate, also called the pulse repetition frequency (PRF).

It is to be noted that, in all diagrams of FIGS. 1, 7 and 9, the time behavior of signal amplitude A is plotted against a time t. In the associated FIGS. 2, 8 and 10, the frequency spectra belonging, in each case, to the signals of FIGS. 1, 7 and 9 are shown, in terms of magnitude of the signals in dB plotted against the frequency f.

As described above, the invention aims to optimize broadband transmission pulse signals, for example TDR transmission pulses, which are transmitted with the pulse repetition frequency PRF. To this end, the polarity of the transmission pulses is switched with each PRF cycle, depending on a random sequence. It has been found, that those random sequences are most effective, which have statistically equally distributed values. The most well know random sequence of this kind and which is simply digitally implementable, is the so-called PN-coding. PN stands for Pseudo-Noise, which means a random sequence of digital 0, 1 values following one after the other, which are issued statistically equally distributed, however with a periodicity. In principle, this is a digitally produced noise, with exactly adjustable periodicity.

FIG. 3 shows an example of an embodiment of such a circuit of a PN-code generator 10 of the invention, with which the method of the invention for optimizing emission of broadband transmission pulses is implemented. PN-code generator 10 is constructed as an n-stage, shift register Q with feedback taps connected via an XOR gate 12. The individual stages Q1-Qn, preferably at least two stages, form the n-bit shift register using a shift register clocking signal, which shifts an input value at a data input D by one more register position upon each clock signal TAKT. TAKT stands, in this case, for the pulse repetition frequency, which is, thus, likewise applied to the shift register Q at the input CLK. By the feedback of at least two shift register outputs through the XOR-gate 12, a data input value D is obtained. Produced on the output side of the PN-code generator 10 is a random sequence PNCode, which is used as control signal and code for a switching of the invention for producing a transmission signal in the circuits of FIGS. 4, 5 and 6, wherein, depending on the random sequence PNCode, the polarity of the transmission signal is reversed.

A fundamental concept to keep in mind here is that the periodicity, with which the random sequence repeats, depends on the length of a shift register. The greater the number of stages Q1-Qn, the longer the time, until the random sequence repeats. For the PN-code generator 10 illustrated in FIG. 3, however, for most cases of application, the number of stages Q1-Qn and, thus, the length of the shift register can be so chosen that the resulting random sequence can be considered as a non-periodic sequence. Random sequences with e.g. Gaussian distribution or other statistically non-equally distributed sequences are, it is true, possible, but they are not so effective. Found to be especially effective, however, is a shift register Q with a bit-width of 9 bits, thus nine register stages Q1-Q9, with which a random sequence PNcode having a length of 511 nearly equally distributed 0, 1 pulses can be produced: 254 positive values, 255 negative values.

The actual circuit of the invention for producing a broadband transmission signal having a polarity coded by the random sequence PNcode produced in the PN-code generator 10 (see FIG. 3) can be implemented in different ways. Examples of embodiments therefor are shown in FIGS. 4-6. Either two transmission signal generators Sender A and Sender B are used therefor, each of which produces a transmission signal of different polarity, or else a single transmission signal generator Sender C with switchable polarity is used.

The polarity reversal is effected, in the case of the circuit shown in FIG. 4, using a switch 14, which, depending on the polarity code PNcode applied to it, switches back and forth between the outputs of the two transmission signal generators Sender A and Sender B. Applied on the input sides of the transmission signal generators Sender A and Sender B is the pulse repetition frequency TAKT.

In the case of the circuit illustrated in FIG. 6, a switch 16 is connected to the inputs of the transmission signal generators Sender A and Sender B. Switch 16 switches back and forth between the inputs of the two transmission signal generators Sender A and Sender B, depending on the polarity code PNCode being applied to it.

The situation is different in the case of the circuit illustrated in FIG. 5, where the polarity code PNCode is applied directly to the input of the signal generator Sender C, whose polarity is itself thereby switchable.

FIGS. 7-10 illustrate the marked reduction of the emission values of the polarity-coded, broadband, transmission signals produced with the invention. In the case of a PN-value=1 for the random sequence PNCode produced in the PN-code generator 10 (see, in this connection, FIG. 3), the circuits of FIGS. 4-6 issue a positive transmission pulse, while, in the case of a PN-value=0, a pulse of the same pulse shape but of negative polarity is issued. This situation is illustrated in FIG. 9.

It is, however, also possible, not only to reverse the polarity of the transmission signals in a coded manner, but, also, to suppress pulses, depending on a random sequence PNCode. The special effect of such a method can also be illustrated by the example of a needle pulse sequence as transmission signals shown in FIG. 7. In comparison with a conventional, uncoded, needle pulse sequence of FIG. 1 and the emission spectrum shown in FIG. 2, the magnitude, or emission, spectrum shown in FIG. 8 for the coded needle pulse sequence of FIG. 7 already shows a clear reduction of the emission values.

Yet more marked is the effect of the optimizing of the emission values in FIGS. 9 and 10, which illustrate a polarity-coded pulse sequence of the invention. The signals shown there were produced by means of a PN-code generator 10 of FIG. 3 with a 7-bit shift register. In FIG. 9, clearly visible are the negative and positive pulses of the polarity-coded, pulse sequence. The associated magnitude, or emission, spectrum of FIG. 10 shows that the absolute level of the emission has been drastically lowered.

For all described transmission signals, it has been found that it can be of advantage, when the pulse repetition frequency TAKT is constantly, or additionally, jittered.

### LIST OF REFERENCE CHARACTERS

A amplitude
D data input of Q
f frequency
t time
PNCode pseudo-noise code
Q shift register
Q1-Qn stages of shift register
Sender A transmission signal generator
Sender B transmission signal generator
Sender C transmission signal generator
TAKT clocking rate for control of pulse repetition frequency
10 PN-code generator
12 XOR-gate
14 switch
16 switch

1-11. (canceled)

12. A method for optimizing emission of broadband transmission pulses of a pulse echo method, comprising the steps of:
transmitting transmission pulses with a preselected pulse repetition frequency (TAKT); and
switching the polarity of a pulse with each cycle of the pulse repetition frequency (TAKT), depending on a random sequence (PNCode).

13. The method as claimed in claim 12, wherein:
the pulse repetition frequency (TAKT) is constant.

14. The method as claimed in claim 12, wherein:
the pulse repetition frequency (TAKT) is additionally jittered.

15. The method as claimed in claim 12, wherein:
the pulse form of the transmission pulse is of any shape.

16. A method for optimizing emission of broadband transmission pulses of a pulse echo method, comprising the steps of:
transmitting transmission pulses with a preselected pulse repetition frequency (TAKT); and
suppressing individual pulses with each cycle of the pulse repetition frequency (TAKT), depending on a random sequence (PNCode).

17. The method as claimed in claim 16, wherein:
the pulse repetition frequency (TAKT) is constant.

18. The method as claimed in claim 16, wherein:
the pulse repetition frequency (TAKT) is additionally jittered.

19. The method as claimed in claim 16, wherein:
the pulse form of the transmission pulse is of any shape.

20. A circuit for optimizing emission of broadband transmission pulses of a pulse echo method, comprising:
two transmission signal generators (Senders A, B) of differing polarity, between whose output signals switching occurs back and forth, depending on a produced, random sequence (PNCode).

21. A circuit for optimizing emission of broadband, transmission pulses of a pulse echo method, comprising:
two transmission signal generators (Senders A, B) of differing polarity, which are switched in and out, depending on a produced, random sequence (PNCode).

22. A circuit for optimizing emission of broadband transmission pulses of a pulse echo method, comprising:
a transmission signal generator (Sender C) which can be switched in its polarity and which is switched, depending on a produced, random sequence (PNCode).

23. The circuit as claimed in claim 20, wherein:
the random sequence (PNCode) is a PN-code sequence produced by a PN-code generator circuit.

24. The circuit as claimed in claim 23, wherein:
said PN-code generator circuit comprises a multi-stage, shift register (Q1-Qn) having feedback taps.

25. The circuit as claimed in claim 24, further comprising:
an XOR-gate for the feedback taps.

26. The circuit as claimed in claim 21, wherein:
the random sequence (PNCode) is a PN-code sequence produced by a PN-code generator circuit.

27. The circuit as claimed in claim 26, wherein:
said PN-code generator circuit comprises a multi-stage, shift register (Q1-Qn) having feedback taps.

28. The circuit as claimed in claim 27, further comprising:
an XOR-gate for the feedback taps.

29. The circuit as claimed in claim 22, wherein:
said PN-code generator circuit comprises a multi-stage, shift register (Q1-Qn) having feedback taps.

30. The circuit as claimed in claim 29, wherein:
said PN-code generator circuit comprises a multi-stage, shift register (Q1-Qn) having feedback taps.

31. The circuit as claimed in claim 30, wherein:
said PN-code generator circuit comprises a multi-stage, shift register (Q1-Qn) having feedback taps.
